(19) United States
(12) Patent Application Publication
(10) Pub. No.: US 2010/0122877 A1
(43) Pub. Date: May 20, 2010

(54) ELECTRIC DISC BRAKE

(75) Inventor: Joo Gon KIM, Gyeonggi-do (KR)

Correspondence Address: LADAS & PARRY, 5670 WILSHIRE BOULEVARD, SUITE 2100, LOS ANGELES, CA, 90036-5679, US

(73) Assignee: MANDO CORPORATION, Gyeonggi-do (KR)

(21) Appl. No.: 12/619,493

(22) Filed: Nov. 16, 2009

(30) Foreign Application Priority Data
Nov. 19, 2008 (KR) 10-2008-115152
Nov. 19, 2008 (KR) 10-2008-115153

(51) Int. Cl. F16D 55/08

(52) U.S. Cl. 188/72.8

(57) ABSTRACT

An electric disc brake including friction pads to press a disc, a carrier to support the friction pads, a caliper housing supported by the carrier to be movable back and forth so as to press the friction pads, and a pressing device to press the friction pads. The pressing device includes a pressing member mounted to the caliper housing and moved back and forth to thereby press and release any one of the friction pads, a screw axis connected to the pressing member, a drive shaft constituted by a worm wheel connected to the screw axis and a worm engaged with the worm wheel and mounted across the screw axis, and a motor rotating the drive shaft forward and backward.

### CROSS-REFERENCE TO RELATED APPLICATION(S)

This application claims the benefit of Korean Patent Application No. 2008-0115153 and No. 2008-0115152, filed on Nov. 19, 2008 in the Korean Intellectual Property Office, the disclosure of which is incorporated herein by reference.

### BACKGROUND

1. Field

Embodiments of the present invention relate to an electric disc brake capable of achieving a great braking force.

2. Description of the Related Art

Differently from general hydraulic disc brakes, electric disc brakes employ an electric motor as a power source of a driving device to press a friction pad.

Such an electric disc brake is disclosed in KR Patent Publication No. 2003-93691. The electric disc brake includes a motor rotating forward and backward to brake and release wheels, a screw gear unit connected to a rotational shaft of the motor, and a piston pressing a friction pad by moving back and forth according to rotation of the screw gear unit.

However, in the conventional electric disc brake, the screw gear unit that drives the piston back and forth is in direct connection with the rotational shaft of the motor. Therefore, it is difficult to generate a great driving force.

### SUMMARY

Therefore, it is an aspect of the present invention to provide an electric disc brake capable of generating a great braking force.

Additional aspects of the invention will be set forth in part in the description which follows and, in part, will be obvious from the description, or may be learned by practice of the invention.

In accordance with one aspect of the present invention, an electric disc brake includes friction pads to press a disc, a carrier to support the friction pads, a caliper housing supported by the carrier to be movable back and forth so as to press the friction pads, and a pressing device to press the friction pads, wherein the pressing device includes a pressing member mounted to the caliper housing and moved back and forth to thereby press and release any one of the friction pads, a screw axis connected to the pressing member, a drive shaft mounted across the screw axis, a motor rotating the drive shaft forward and backward, and a worm gear including a worm wheel connected to the screw axis and a worm formed at the drive shaft and engaged with the worm wheel, so as to transmit rotation of the drive shaft to the screw axis, and the screw axis and the worm wheel of the worm gear are disposed in the center of an inner space of the caliper housing while the motor is disposed at the outside of the caliper housing eccentrically from the center according to a mounting position of the worm gear.

The pressing device may further include a motor shaft and a reduction gear device mounted to the drive shaft, so that rotation of the motor is reduced and transmitted to the drive shaft.

The reduction gear device may include a drive gear mounted to the motor shaft, and a driven gear having a greater number of teeth than the drive gear, being mounted to the drive shaft to be meshed with the drive gear.

The reduction gear device may include a sun gear mounted to the motor shaft, a plurality of planet gears arranged around the sun gear and meshed with the sun gear, an inscribing gear fixed to outsides of the planet gears to be meshed with the planet gears, and a carrier connecting axes of the planet gears with the drive shaft.

In accordance with another aspect of the present invention, in an electric disc brake including friction pads to press a disc, a carrier to support the friction pads, a caliper housing supported by the carrier to be movable back and forth so as to press the friction pads, and a pressing device to press the friction pads, the pressing device may include a pressing member mounted to the caliper housing and moved back and forth to thereby press and release any one of the friction pads, a screw axis connected to the pressing member, a drive shaft mounted across the screw axis, a motor rotating the drive shaft forward and backward, and a worm gear including a worm wheel connected to the screw axis and a worm formed at the drive shaft and engaged with the worm wheel, so as to transmit rotation of the drive shaft to the screw axis, and the motor may be disposed in the center of the caliper housing at the outside of the caliper housing while the screw axis and the worm gear are disposed in the caliper housing eccentrically from the center by as much as the size of the drive shaft and a radius of the worm wheel.

The pressing member may have an extended end extended toward the center of the friction pad.

In accordance with a further aspect of the present invention, in an electric disc brake comprising friction pads to press a disc, a carrier to support the friction pads, a caliper housing supported by the carrier to be movable back and forth so as to press the friction pads, and a pressing device to press the friction pads, the pressing device may include a pressing member mounted to the caliper housing and moved back and forth to thereby press and release any one of the friction pads, a screw axis connected to the pressing member, a drive shaft mounted across the screw axis, a motor rotating the drive shaft forward and backward, a worm gear including a worm wheel connected to the screw axis and a worm formed at the drive shaft and engaged with the worm wheel, so as to transmit rotation of the drive shaft to the screw axis, and a reduction gear device mounted to the motor shaft and the drive shaft so as to reduce rotation of the motor and transmit the reduced rotation to the drive shaft.

The reduction gear device may include a drive gear mounted to the motor shaft, and a driven gear having a greater number of teeth than the drive gear, being mounted to the drive shaft to be meshed with the drive gear.

The reduction gear device may include a sun gear mounted to the motor shaft, a plurality of planet gears arranged around the sun gear and meshed with the sun gear, an inscribing gear fixed to outsides of the planet gears to be meshed with the planet gears, and a carrier connecting axes of the planet gears with the drive shaft.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a sectional view showing an electric disc brake according to an embodiment of the present invention;

FIG. 2 is a view schematically showing a pressing device of the electric disc brake shown in FIG. 1;

FIG. 3 is a sectional view of an electric disc brake according to another embodiment of the present invention;

FIG. 4 is a sectional view of an electric disc brake according to still another embodiment of the present invention;

FIG. 5 is a sectional view of an electric disc brake according to a further embodiment of the present invention;

FIG. 6 is a sectional view of FIG. 5 cut along a line A-A′; and

FIG. 7 is a view of an electric disc brake according to a further embodiment of the present invention, showing another version of a reduction gear device.

### DETAILED DESCRIPTION

Reference will now be made in detail to the embodiments of the present invention, examples of which are illustrated in the accompanying drawings, wherein like reference numerals refer to like elements throughout.

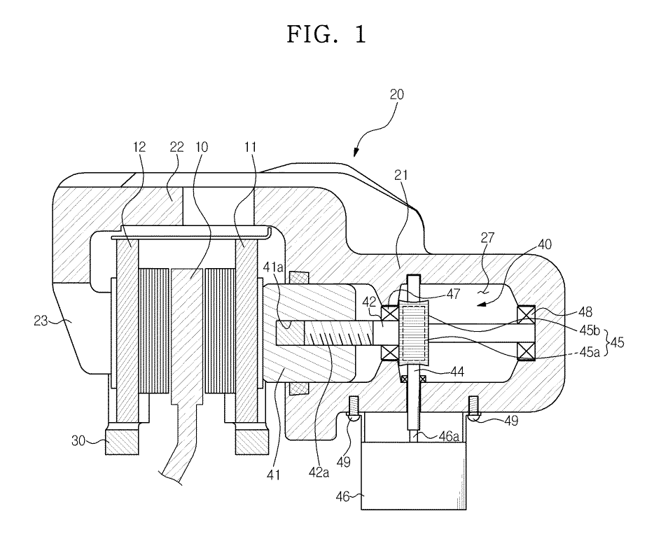

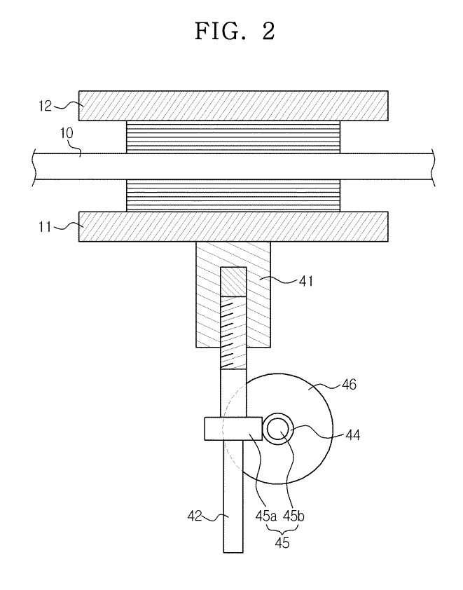

FIG. 1 is a sectional view showing an electric disc brake according to an embodiment of the present invention, and FIG. 2 is a view schematically showing a pressing device of the electric disc brake shown in FIG. 1.

As shown in FIG. 1, the electric disc brake includes a disc 10 rotated with wheels of a vehicle, first and second friction pads 11 and 12 disposed at both sides of the disc 10, respectively, a caliper housing 20 pressing the first and the second friction pads 11 and 12, and a pressing device 40 mounted to the caliper housing 20 to perform the braking operation.

The first and the second friction pads 11 and 12 are supported by a carrier 30 fixed to a vehicle body, to be movable back and forth with respect to both sides of the disc 10. The caliper housing 20 is also supported by the carrier 30 to be movable back and forth in a direction to press the friction pads 11 and 12.

The caliper housing 20 includes a hollow housing body 21, an extension part 22 extended from the housing body 21 toward the second friction pad 12, and a finger part 23 connected to the extension part 22 to support a rear side of the second friction pad 12. The pressing device 40 is mounted to the housing body 21 of the caliper housing 20 so as to press the first friction pad 11.

As shown in FIGS. 1 and 2, the pressing device 40 includes a pressing member 41 mounted in the housing body 21 to be movable back and forth so as to apply and release pressure to and from the first friction pad 11, a screw axis 42 connected to the pressing member 41, a drive shaft 44 mounted across the screw axis 42, a motor 46 rotating the drive shaft 44 forward and backward, and a worm gear 45 transmitting rotation of the drive shaft 44 to the screw axis 42.

The pressing member 41 is mounted inside the housing body 21 to be moved back and forth in a state of being restricted in rotation. The pressing member 41 includes a female screw part 41a connected to the screw axis 42. Here, restriction in rotation of the pressing member 41 may be achieved by forming an outer surface of the pressing member 41 and an inner surface of the housing body 21 into polygonal shapes correspondingly connected to each other. Alternatively, guide units (not shown) in the form of a key and a key recess may be formed at the outer surface of the pressing member 41 and the inner surface of the housing body 21, respectively, to restrict the rotation.

The screw axis 42 includes a male screw part 42a formed at one side to be engaged with the female screw part 41a. The screw axis 42 is rotatably mounted in the housing body 21, being parallel with the moving direction of the pressing member 41. A first bearing 47 and a second bearing 48 are mounted in the housing body 21, separately by a predetermined interval, so as to support the screw axis 42.

The worm gear 45 includes a worm wheel 45a connected to an outer surface of the screw axis 42 to rotate in a vacant space 27 in the housing body 21, and a worm 45b formed at the drive shaft 44 mounted across the screw axis 42. The worm 45b is engaged with the worm wheel 45a.

The drive shaft 44 is rotatably supported by the housing body 21. A part of the drive shaft 44 where the worm 45b is mounted is inserted in the housing body 21. One end of the drive shaft 44 is extended to the outside of the housing body 21, penetrating a lower part of the housing body 21.

The motor 46 is fixed to the lower part of the housing body 21 of the caliper housing 20 by fixing screws 49.

As shown in FIG. 2, the screw axis 42 of the pressing device 40 and the worm wheel 45a of the worm gear 45 are disposed in the center of the inside of the housing body 21. On the other hand, the motor 46 is disposed eccentrically from the center of the housing body 21 according to the eccentric position of the worm 45b.

Hereinafter, the operation of the electric disc brake will be described.

When an operator orders a braking operation, the motor 46 is rotated in a direction to perform braking. When the operator releases the braking operation, the motor 46 is rotated in a reverse direction with respect to the braking direction so as to release the braking.

As the motor 46 rotates for the braking, the drive shaft 44 is rotated.

When the worm 45b is rotated by rotation of the drive shaft 44, the worm wheel 45a engaged with the worm 45b is rotated. When the worm wheel 45a is rotated, the screw axis 42 is accordingly rotated. Here, speed reduction is achieved by a great reduction gear ratio between the worm 45b and the worm wheel 45a. Therefore, a rotational force transmitted to the screw axis 42 is further increased in direct proportion to the reduction of the rotation of the screw axis 42.

When the screw axis 42 is rotated, the pressing member 41 moves toward the first friction pad 11, thereby pressing the first friction pad 11. As a reaction to this, the caliper housing 20 is moved in the opposite direction to a moving direction of the pressing member 40, such that the finger part 34 presses the second friction pad 12 toward the disc 10. Thus, the braking is performed. On the other hand, when the motor 46 is rotated in the reverse direction, the pressing member 41 is moved in a direction for releasing pressure from the first friction pad 11, thereby releasing the braking operation.

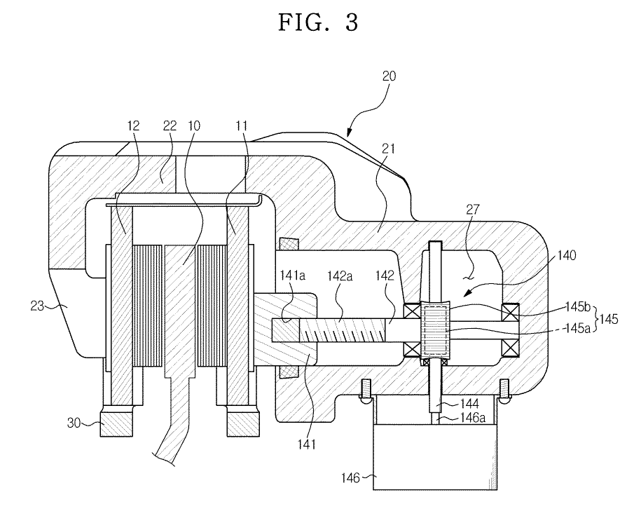

FIG. 3 is a sectional view of an electric disc brake according to another embodiment of the present invention. In the following description, the same elements as in one embodiment described above will not be repeatedly explained.

Referring to FIG. 3, the electric disc brake of this embodiment includes a pressing member 141, a screw axis 142 connected to a female screw part 141a of the pressing member 141, and a worm gear 145 constituted by a worm wheel 145a connected to the screw axis 142 and a worm 145b engaged with the worm wheel 145a. While the pressing member 141, the screw axis 142 and the worm gear 145 are disposed eccentrically from the center of the inside of the housing body 21, a motor 146 is mounted in the center in the housing body 21.

More specifically, since the motor 146 is mounted in the central position, the screw axis 142 and the worm gear 145 are mounted eccentrically from the center by as much as the size of a drive shaft 144 and a radius of the worm wheel 145a.

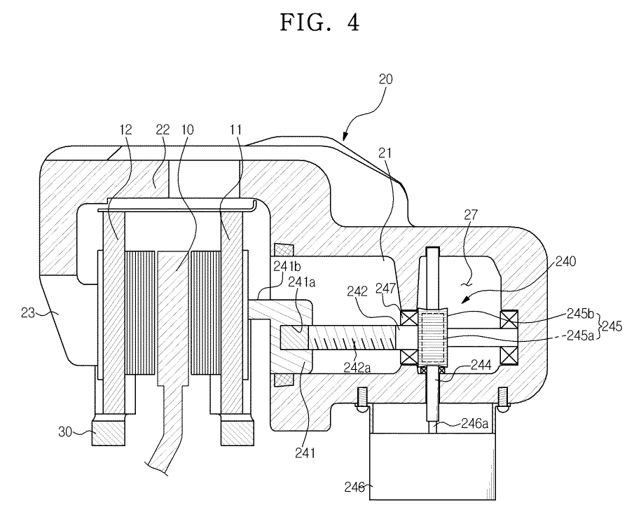

FIG. 4 is a sectional view of an electric disc brake according to still another embodiment of the present invention. In the following description, the same elements as in one embodiment described above will not be repeatedly explained.

According to this embodiment as shown in FIG. 4, a pressing member 241, a screw axis 242 connected to a female screw part 241a of the pressing member 241, and a worm gear 245 constituted by a worm wheel 245a connected to the screw axis 242 and a worm 245b engaged with the worm wheel 245a are disposed eccentrically from the center of the inside of the housing body 21. However, a motor 246 is disposed in the center in the housing body 21.

Here, the center of the pressing member 241, which is connected with the screw axis 242, is disposed eccentrically from the first friction pad 11. The pressing member 241 has an extended end 241 b extended toward the center of the first friction pad 11 so that a pressing force is efficiently transmitted to the center of the first friction pad 11.

More specifically, a pressing device 240 may be disposed in a manner that the center of the pressing member 241 is eccentrically disposed due to the worm gear 245. However, since the pressing force is transmitted through the extended end 241 b of the pressing member 241 extended to the center of the first friction pad 11, transmission of the pressing force to the first friction pad 11 may be favorably performed.

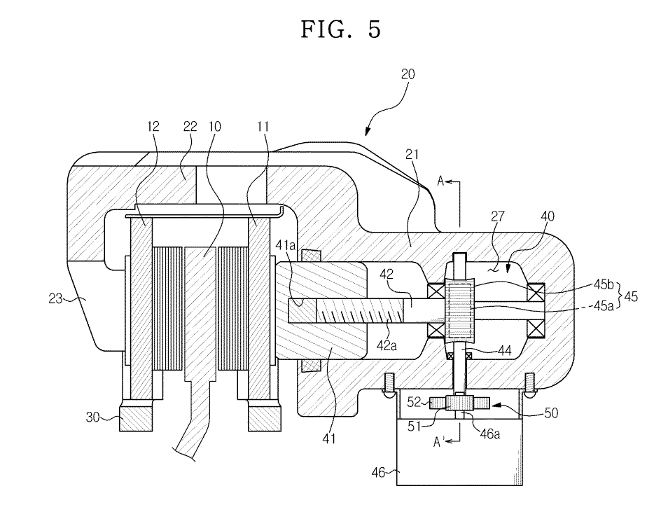

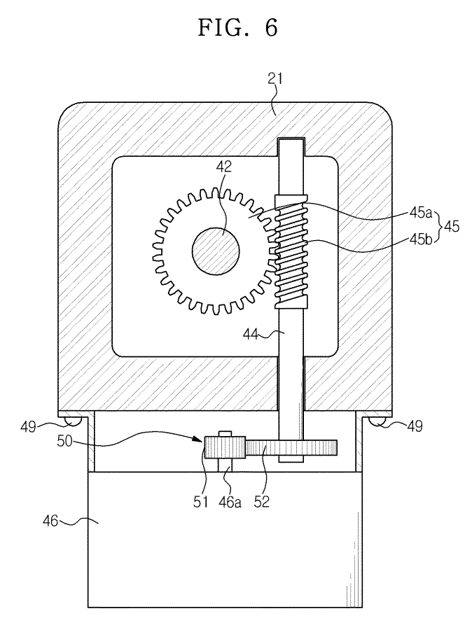

FIG. 5 is a sectional view of an electric disc brake according to a further embodiment of the present invention. FIG. 6 is a sectional view of FIG. 5 cut along a line A-A′. The same elements as in the previous embodiments will not be repeatedly explained.

As shown in FIG. 5 and FIG. 6, the pressing device 40 further includes a reduction gear device 50 mounted to a motor shaft 46a and the drive shaft 44 so that rotation of the motor shaft 46a is reduced and transmitted to the drive shaft 44.

The reduction gear device 50 includes a drive gear 51 mounted to the motor shaft 46a, and a driven gear 52 mounted to the drive shaft 44 and meshed with the drive gear 51. The reduction gear device 50 is structured in a manner that the driven gear 52 has a larger number of teeth than the drive gear 51, accordingly achieving speed reduction. The arrangement of the drive gear 51 and the driven gear 52 may be adjusted according to the mounting position of the motor 46. Also, sizes of the gears 51 and 52 may be varied in order to adjust the reduction gear ratio.

The above-structured electric disc brake is operated in the following manner. First, rotation of the motor 46 is primarily reduced by the reduction gear device 50 while being transmitted to the drive shaft 44. Whereas the rotation speed of the drive shaft 44 is reduced according to the primary reduction by the reduction gear device 50, a rotational force transmitted to the drive shaft 44 is increased.

As the worm 45b is rotated by rotation of the driving shaft 44, the worm wheel 45a engaged with the worm 45b is rotated. As the worm wheel 45a rotates, the screw axis 42 is rotated. Here, speed reduction is secondarily performed by a great reduction gear ratio of the worm gear 45. Accordingly, the rotational force transmitted to the screw axis 42 is increased in direct proportion to the reduction in rotation of the screw axis 42.

Specifically, according to the electric disc brake, rotation of the motor 46 is reduced primarily by the reduction gear device 50 and secondarily by the worm gear 45, thereby increasing the rotational force transmitted to the screw axis 42 corresponding to the reduction gear ratio. Accordingly, the pressing member 41 is capable of pressing the first friction pad 11 with a great force. As a consequence, a great braking force is achieved.

In addition, although the worm gear 45 is provided in the embodiment shown in FIGS. 5 and 6, the screw axis 42 and the worm gear 45 are disposed in the center of the housing body 21 and the motor 46 is also disposed in the center because of the presence of the reduction gear device 50.

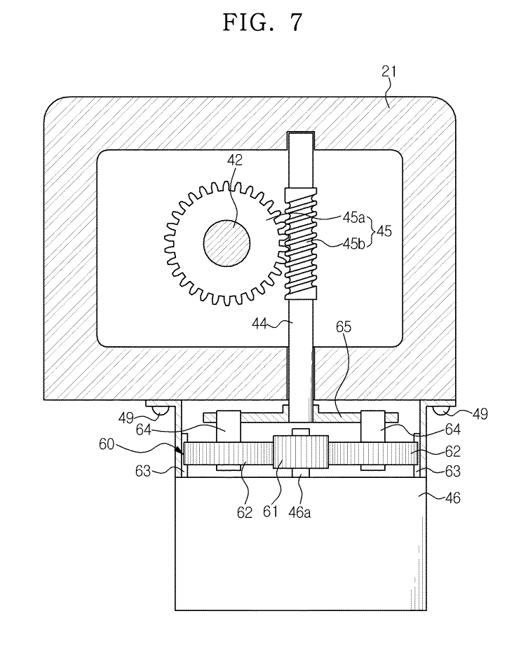

FIG. 7 is a sectional view of an electric disc brake according to a further embodiment of the present invention. In the following description, the same elements as in one embodiment described above will not be repeatedly explained.

The present embodiment suggests another reduction gear device 60 that connects a motor shaft with a drive shaft.

The reduction gear device 60 includes a sun gear 61 mounted to the motor shaft 46a, a plurality of planet gears 62 arranged around the sun gear 61 and meshed with the sun gear 61, an inscribing gear 63 fixed to outsides of the planet gears 62 to be meshed with the planet gears 62, and a carrier 65 connecting axes 64 of the planet gears 62 with the drive shaft 44. The reduction gear device 60 operates in the following manner. When the sun gear 61 rotates by the operation of the motor 46, the planet gears 62 are rotated, transmitting the rotation to the drive shaft 44 through the carrier 65. As a result, the drive shaft 44 performs reduction rotation.

More specifically, rotation of the motor 46 is primarily reduced by the reduction gear device 60 and secondarily by the worm gear 45, accordingly increasing the rotational force transmitted to the screw axis 42 corresponding to the reduction gear ratio. Therefore, the pressing member 41 is capable of pressing the first friction pad 11 with a great force. As a consequence, a great braking force is achieved.

As is apparent from the above description, in accordance with an electric disc brake according to the embodiments of the present invention, rotation of a motor is reduced by a worm gear. Therefore, a pressing member is able to pressing a first friction pad by a great force, accordingly achieving a great brake force.

Since the reduction is performed during transmission of rotation of the motor to a screw axis, a sufficient braking force may be obtained even with a small-size and small-output motor. As a result, the volume of the device may be accordingly reduced.

In addition, according to the embodiments of the present invention, the screw axis and a motor shaft may be mounted in different directions from each other. Therefore, the motor may be mounted at a lower part of a caliper housing body, accordingly reducing the length of the device in the screw axis direction.

Furthermore, in the electric disc brake according to the embodiments, since rotation of the motor is primarily reduced by the reduction gear device before being transmitted to the worm gear, the pressing member is able to press the first friction pad by a great force. Consequently, a great braking force may be generated.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electric disc brake comprising friction pads to press a disc, a carrier to support the friction pads, a caliper housing supported by the carrier to be movable back and forth so as to press the friction pads, and a pressing device to press the friction pads, wherein the pressing device comprises:
a pressing member mounted to the caliper housing and moved back and forth to thereby press and release any one of the friction pads;
a screw axis connected to the pressing member;
a drive shaft mounted across the screw axis;
a motor rotating the drive shaft forward and backward; and
a worm gear including a worm wheel connected to the screw axis and a worm formed at the drive shaft and engaged with the worm wheel, so as to transmit rotation of the drive shaft to the screw axis, and
the screw axis and the worm wheel of the worm gear are disposed in the center of an inner space of the caliper housing while the motor is disposed at the outside of the caliper housing eccentrically from the center according to a mounting position of the worm gear.

2. The electric disc brake according to claim 1, wherein the pressing device further comprises a motor shaft and a reduction gear device mounted to the drive shaft, so that rotation of the motor is reduced and transmitted to the drive shaft.

3. The electric disc brake according to claim 2, wherein the reduction gear device comprises:
a drive gear mounted to the motor shaft; and
a driven gear having a greater number of teeth than the drive gear, being mounted to the drive shaft to be meshed with the drive gear.

4. The electric disc brake according to claim 2, wherein the reduction gear device comprises:
a sun gear mounted to the motor shaft;
a plurality of planet gears arranged around the sun gear and meshed with the sun gear;
an inscribing gear fixed to outsides of the planet gears to be meshed with the planet gears; and
a carrier connecting axes of the planet gears with the drive shaft.

5. An electric disc brake comprising friction pads to press a disc, a carrier to support the friction pads, a caliper housing supported by the carrier to be movable back and forth so as to press the friction pads, and a pressing device to press the friction pads, wherein the pressing device comprises:
a pressing member mounted to the caliper housing and moved back and forth to thereby press and release any one of the friction pads;
a screw axis connected to the pressing member;
a drive shaft mounted across the screw axis;
a motor rotating the drive shaft forward and backward; and
a worm gear including a worm wheel connected to the screw axis and a worm formed at the drive shaft and engaged with the worm wheel, so as to transmit rotation of the drive shaft to the screw axis, and
the motor is disposed in the center of the caliper housing at the outside of the caliper housing while the screw axis and the worm gear are disposed in the caliper housing eccentrically from the center by as much as the size of the drive shaft and a radius of the worm wheel.

6. The electric disc brake according to claim 5, wherein the pressing member has an extended end extended toward the center of the friction pad.

7. An electric disc brake comprising friction pads to press a disc, a carrier to support the friction pads, a caliper housing supported by the carrier to be movable back and forth so as to press the friction pads, and a pressing device to press the friction pads, wherein the pressing device comprises:
a pressing member mounted to the caliper housing and moved back and forth to thereby press and release any one of the friction pads;
a screw axis connected to the pressing member;
a drive shaft mounted across the screw axis;
a motor rotating the drive shaft forward and backward;
a worm gear including a worm wheel connected to the screw axis and a worm formed at the drive shaft and engaged with the worm wheel, so as to transmit rotation of the drive shaft to the screw axis; and
a reduction gear device mounted to the motor shaft and the drive shaft so as to reduce rotation of the motor and transmit the reduced rotation to the drive shaft.

8. The electric disc brake according to claim 7, wherein the reduction gear device comprises:
a drive gear mounted to the motor shaft; and
a driven gear having a greater number of teeth than the drive gear, being mounted to the drive shaft to be meshed with the drive gear.

9. The electric disc brake according to claim 7, wherein the reduction gear device comprises:
a sun gear mounted to the motor shaft;
a plurality of planet gears arranged around the sun gear and meshed with the sun gear;
an inscribing gear fixed to outsides of the planet gears to be meshed with the planet gears; and
a carrier connecting axes of the planet gears with the drive shaft.
